(19) United States
(12) Patent Application Publication
(10) Pub. No.: US 2007/0031114 A1
(43) Pub. Date: Feb. 8, 2007

(54) Method for selectively reproducing main title in optical disc device

(75) Inventor: Han Seop Ryu, Suwon-si (KR)

Correspondence Address: BIRCH STEWART KOLASCH & BIRCH, PO BOX 747, FALLS CHURCH, VA, 22040-0747, US

(73) Assignee: LG Electronics, Inc., Seoul (KR)

(21) Appl. No.: 11/481,954

(22) Filed: Jul. 7, 2006

(30) Foreign Application Priority Data
Jul. 7, 2005 (KR) 10-2005-0061262

(51) Int. Cl. H04N 7/00

(52) U.S. Cl. 386/95

(57) ABSTRACT

A method and apparatus for reproducing data, are discussed. According to an embodiment, the method includes determining, by a recording medium device, whether or not there is a reproduction history of an inserted recording medium in the recording medium device, and directly accessing and reproducing at least one main title from the recording medium if the determining step determines that there is a reproduction history of the recording medium in the recording medium device.

This application claims the benefit of the Korean Patent Application No. 10-2005-0061262 filed on Jul. 7, 2005 in Republic of Korea, the entire contents of which are hereby fully incorporated by reference.

### BACKGROUND OF THE INVENTION

1. Field of the Invention

The present invention relates to a method for selectively reproducing main titles in an optical disc device, and more particularly to a method for selectively reproducing only main titles of a previously reproduced disc.

2. Description of the Related Art

As generally known in the art, optical discs such as digital versatile discs (DVD), which are capable of storing high definition video data and high quality audio data with high capacity, and optical disc devices capable of recording data on the optical discs and reproducing the data are widely used.

If an optical disc is inserted into an optical disc device such as a DVD-player, the optical disc device reads out navigation information recorded in a specific area such as a lead-in area of the inserted optical disc so as to store the navigation information in a memory embedded in the optical disc device. Then, the optical disc device reproduces warnings (e.g., copyright information), previews and/or advertisements recorded in a header of a data area of the optical disc and then sequentially reproduces recorded main titles (e.g., movie) next to the header based on the downloaded navigation information.

In other words, the optical disc device performs a sequential reproduction operation defined in a disc reproduction standard such that a user can view main titles after watching the warnings, advertisements, previews, etc.

However, if the conventional sequential reproduction operation is applied to an optical disc, especially to the discs which have been previously reproduced, the user may repeatedly view the same warnings, advertisements, and preview. And there is no way for the user to bypass the warnings and/or advertisements displayed automatically after the user inserts the optical disc into the optical disc device.

### SUMMARY OF THE INVENTION

Accordingly, the present invention has been made to address the above-mentioned and other problems associated with the related art.

An object of the present invention is to provide a method and apparatus for selectively reproducing only main titles of a recording medium such as an optical disc, which has been previously reproduced.

In order to accomplish these and other objects of the present invention, there is provided according to an embodiment a method for selectively reproducing main titles in a disc device, including determining whether or not there is a reproduction history of an inserted disc in the disc device, and selectively reproducing main titles if there exists the reproduction history of the inserted disc in the disc device.

In an example of the method, it is determined that the inserted disc has been previously reproduced if information identical to a disc identifier recorded on the disc, or the number of chapters or sectors for a predetermined title of the disc is recorded in the disc device. The predetermined title may be a first title or a title having the longest data length. In addition, a title having the longest data length among titles recorded on the disc may be selected as a main title based on navigation information about the disc.

According to another example of the present invention, all data of the disc are sequentially reproduced in a disc device if the disc has not been previously reproduced in the disc device. Identification information used for determining whether or not there is a reproduction history of the disc in the disc device is stored in the disc device. The identification information corresponds to a disc identifier of the disc, or the number of sectors or chapters for a predetermined title of the disc.

According to another embodiment of the present invention, titles satisfying a predetermined reference can be searched if there is a reproduction history of the disc in the disc device, and the searched titles are selectively reproduced. Here, the predetermined reference is a preset value, and the method determines whether or not a reproduction time of each title exceeds the preset value. A plurality of titles are sequentially reproduced according to a physical recording sequence or a sequence requested by a user if the plurality of titles satisfying the predetermined reference are searched and identified.

According to an aspect of the present invention, there is provided a method for reproducing data in a recording medium device, the method comprising: determining, by the recording medium device, whether or not there is a reproduction history of an inserted recording medium in the recording medium device; and directly accessing and reproducing at least one main title from the recording medium if the determining step determines that there is a reproduction history of the recording medium in the recording medium device.

According to another aspect of the present invention, there is provided an apparatus for reproducing data in a recording medium, the apparatus comprising: a reproducing unit; and a controller to determine whether or not there is a reproduction history of an inserted recording medium in the apparatus, and to control the reproducing unit to directly access and reproduce at least one main title from the recording medium if there is a reproduction history of the recording medium in the apparatus.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the structure of an optical disc device according to an embodiment of the present invention;

FIG. 2 is a view illustrating an example of the selection and reproduction of main titles according to a first embodiment of the present invention;

FIG. 3 is a flowchart illustrating an operational procedure of selectively reproducing only a main title from an optical disc according to the first embodiment of the present invention;

FIG. 4 a view illustrating an example of the selection and reproduction of plural main titles from an optical disc according to a second embodiment of the present invention; and

FIG. 5 is a flowchart illustrating an operational procedure of selectively reproducing plural main titles from an optical disc according to the second embodiment of the present invention.

### DETAILED DESCRIPTION OF PREFERRED EMBODIMENTS

Hereinafter, preferred embodiments of the present invention will be described with reference to the accompanying drawings. In the following description and drawings, the same reference numerals are used to designate the same or similar components, and so repetition of the description on the same or similar components will be omitted.

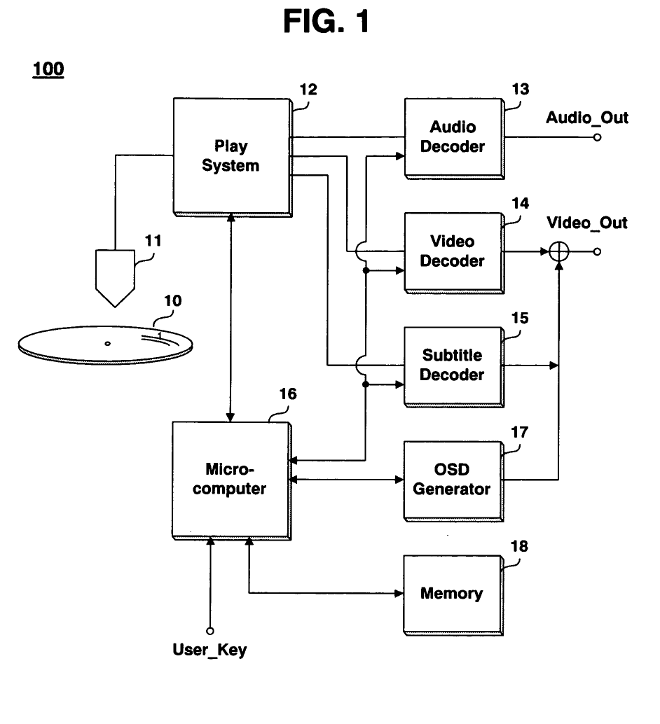

FIG. 1 is a block diagram illustrating the structure of an optical disc device 100 according to the present invention. For example, the optical disc device can be one of various types of optical disc devices such as a DVD-player, etc.

The optical disc device 100 includes an optical pick up unit 11 to record and/or reproduce from a recording medium such as an optical disc 10 inserted therein, a play system 12, an audio decoder 13, a video decoder 14, a subtitle decoder 15, a microcomputer 16, an on screen display (OSD) generator 17, and a memory 18. All the components of the optical disc device 100 are operatively coupled.

The microcomputer 16 determines whether or not an inserted optical disc 10 has been previously reproduced in the same optical disc device 100 based on navigation information read out from a lead-in area (or other designated area) of the inserted optical disc 10. This navigation information is stored in the memory 18.

Generally, when the optical disc 10 is inserted into the optical disc device 100 for the first time, the microcomputer 16 stores a disc identifier (Disc_ID) included in the navigation information for the inserted optical disc 10 in the memory 18 of the optical disc device 100 in order to manage the history of all optical discs or recording mediums inserted in the disc device 100. Thus if the same optical disc 10 is inserted again into the optical disc device 100, the microcomputer 16 determines that the optical disc 10 has been previously reproduced in the optical disc device 100 by searching the memory 18 for the disc ID of the inserted optical disc 10 and finding the match.

For some optical discs or recording mediums, a disc ID may not be recorded on the disc itself. If a disc ID is not recorded in the inserted optical disc, the microcomputer 16 stores the number of sectors or chapters that are present for an N^{th} title of the optical disc in the memory 18 as identification information about the optical disc, where N is any positive integer. For instance, the microprocessor 16 can select a particular title stored on the optical disc and use the number indicating the number of sectors or chapters that are associated with or stored in that title as the means to identify the optical disc. Other ways of identifying an inserted optical disc can be used.

As an example, if an optical disc 10, which has no disc ID, is inserted, the microcomputer 16 searches the memory 18 for information identical to the number of sectors or chapters for the N^{th} title of the optical disc 10, thereby determining whether or not the optical disc 10 has been previously reproduced in the optical disc device 100. The N^{th} title may be the first title (Title #1) recorded in the optical disc, or a main title having the longest data length, for example, the longest data reproduction time. A main title can be considered a title having the longest data length or having a certain data length. Also a title in the DVD art is a high level unit since the levels move from a title, a chapter, a sector, etc. However, the title can represent any certain data level unit.

If the microcomputer 16 determines through the above procedure that an optical disc 10 currently inserted into the optical disc device 100 has not been previously reproduced in the optical disc device 100, the microcomputer 16 performs the conventional sequential reproduction operation so as to sequentially reproduce all data including warning, previews, advertisement data, etc. and a main tide recorded in the optical disc 10 from the beginning part.

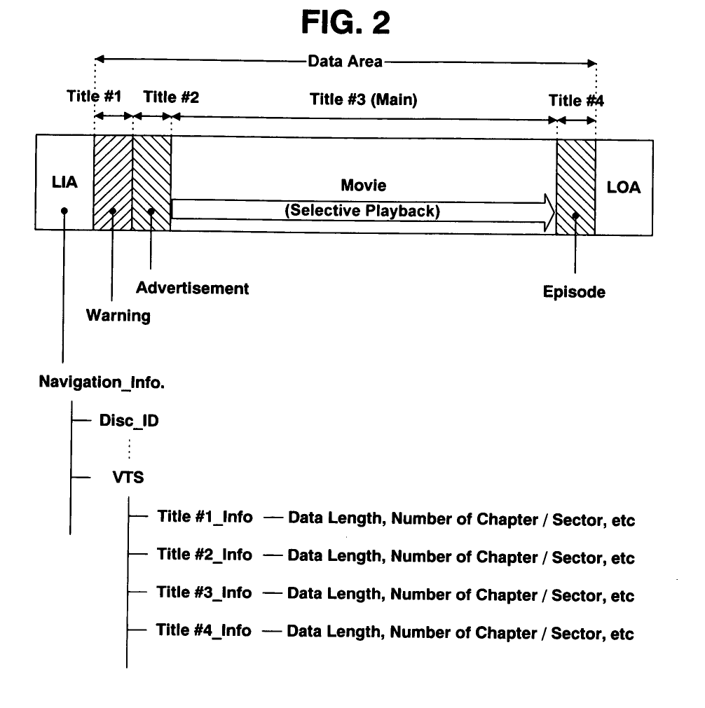

In contrast, if the microcomputer 16 determines that an optical disc 10 currently inserted into the optical disc device 100 has been previously reproduced in the optical disc device 100, as shown in FIG. 2, the microcomputer 16 searches for a main title (e.g., Title #3) having the longest data length based on each title information included in a video title set (VTS) of the navigation information about the optical disc 10, skips warnings, previews, advertisement and other similar tides (e.g., Title #1 and Title #2) recorded in a header area of the data area of the optical disc 10, and directly reproduces only the main title (Title #3). That is, reproduction of the warnings, previews and/or advertisements allotted at the beginning of the disc reproduction process is bypassed if the optical disc device 100 determines that the currently inserted optical disc has been reproduced previously in the optical disc device 100. Hereinafter, the description about this operation is given.

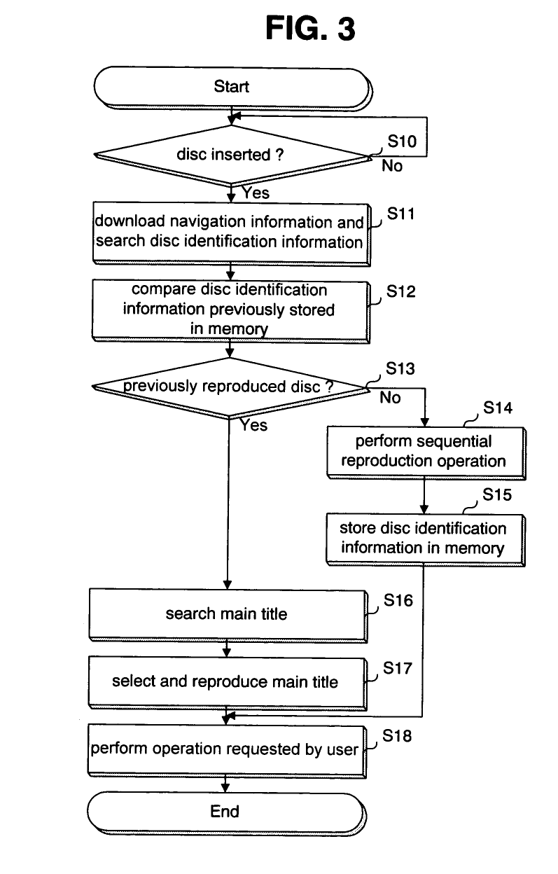

FIG. 3 is a flowchart illustrating an operational procedure of selectively reproducing only main title(s) by an optical disc device according to an embodiment of the present invention. This procedure is implemented in the optical disc device 100 of FIG. 1; however, the present invention is not limited thereto and the procedure can be implemented in other device or system.

Referring to FIG. 3, if an optical disc 10 is inserted into the optical disc device 100 in step S10, the microcomputer 16 reads out navigation information recorded in a specific area such as a lead-in area of the optical disc 10 so as to download the navigation information into the memory 18 by controlling the operation of the play system 12 instep S11. The navigation information is then stored in the memory 18 so as to manage control data required for the reproduction of the optical disc 10, and this storage operation is different from an operation of storing disc identification information in the memory 18 in order to manage the history of optical discs. In addition, the memory 18 may be classified into a navigation information storing area and a disc identification information storing area such that they are individually managed.

If a disc identifier (Disc_ID) has been recorded in the optical disc 10, that is, if disc identification information of the currently inserted optical disc 10 is searched and found from the navigation information of the currently inserted disc 10 as stored in the memory 18, the microcomputer 16 compares the searched disc ID with disc IDs previously stored in the memory 18 in step S12. If the same disc ID has been stored in the memory 18, it is determined that the inserted optical disc 10 has been previously reproduced in the same optical disc device 100.

If the disc ID is not recorded in the optical disc 10, the microcomputer 16 searches for the number of sectors or chapters for the N^{th} title of the optical disc 10 instead of the disc ID based on the read-out navigation information as discussed above, thereby determining whether or not information identical to the number of sectors or chapters has been previously stored in the memory 18 as disc identification information. Thus the method determines whether or not the inserted optical disc 10 has been previously reproduced in the optical disc device 100 in step S12.

If the same disc ID or the number of chapters or sectors for the N^{th} title is not stored in the memory 18, it is determined that the optical disc 10 has not been previously reproduced in the optical disc device 100.

If it is determined that the optical disc has not been previously reproduced in the optical disc device 100 as described above in step S13, the microcomputer 16 performs a sequential reproduction operation of sequentially reproducing all data including warning, preview and/or advertisement data and a main title recorded in the optical disc 10 based on the navigation information read out and downloaded in the memory 18 in step S14. Here, the sequential reproduction operation involves reproducing the warning, preview and/or advertisement data first and then the main title as done in the related art disc reproduction operation.

Then, the microcomputer 16 stores the disc ID or the number of sectors or chapters for the N^{th} title of the inserted optical disc 10 in the memory 18 as the disc identification information in step S15.

In the meantime, if it is determined that the inserted optical disc 10 has been previously reproduced in the optical disc device 100 in step S13, the microcomputer 16 searches for a main title of the optical disc 10 based on the navigation information read out and downloaded in the memory 18 in step S16. For example, as shown in FIG. 2, a title (e.g., Title #3) having the longest data length is searched based on information about each title included in a video title set of the navigation information as a main title.

Then, the microcomputer 16 performs a main title selection and reproduction operation of skipping warning, preview and/or advertisement data recorded in the optical disc 10 and selectively reproducing only the main title by controlling the operation of the play system 12 in step S17. Then, the microcomputer 16 performs operations requested by a user in step S18.

Accordingly, the microcomputer 16 sequentially reproduces all recorded data with respect to an initially reproduced optical disc. However, the microcomputer 16 reproduces only a main title with respect to an optical disc, which has been previously reproduced in the optical disc device 100, so as to automatically bypass certain information (e.g., copyright warnings, advertisements, previews, etc.) previously reproduced in the optical disc device 100 and to directly and immediately access a desired content such as main title(s).

In the meantime, according to another embodiment of the present invention, not only a main title can be selectively reproduced with respect to an optical disc which has been previously produced, but also a plurality of main titles can be selectively reproduced if the main titles recorded on one optical disc satisfy a predetermined reference.

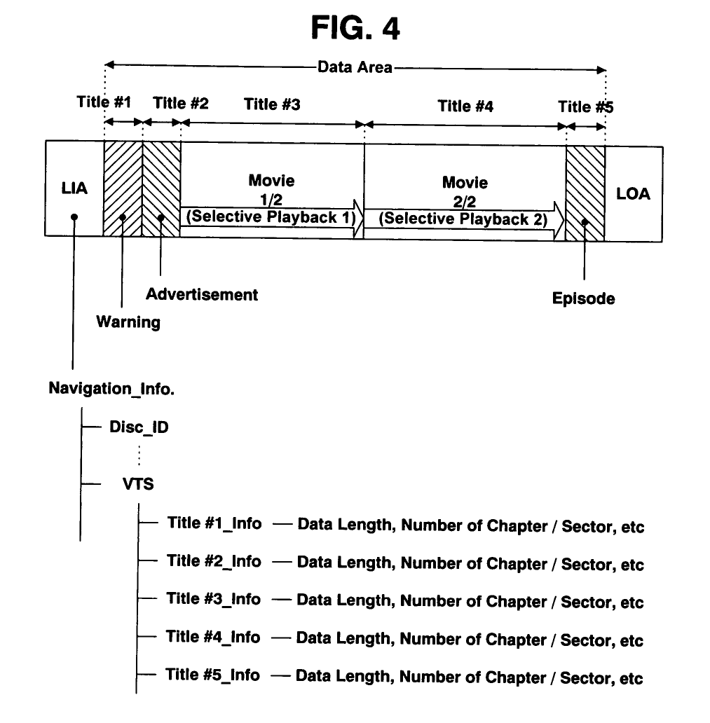

For example, as shown in FIG. 4, if a plurality of main titles (e.g., Title #3 and Title #4) such as a series exceeding a data length preset by a user are recorded in one optical disc, the microcomputer 16 selectively reproduces the plurality of main titles.

The plurality of the main titles are sequentially reproduced according to a physical recording sequence regardless of data lengths, so that a user can sequentially view the plurality of main titles such as a series of a program, different programs, different movies, etc.

In addition, the plurality of the main titles may be reproduced according to a reproduction sequence requested by the user instead of the physical recording sequence. Hereinafter, the description about this operation is given.

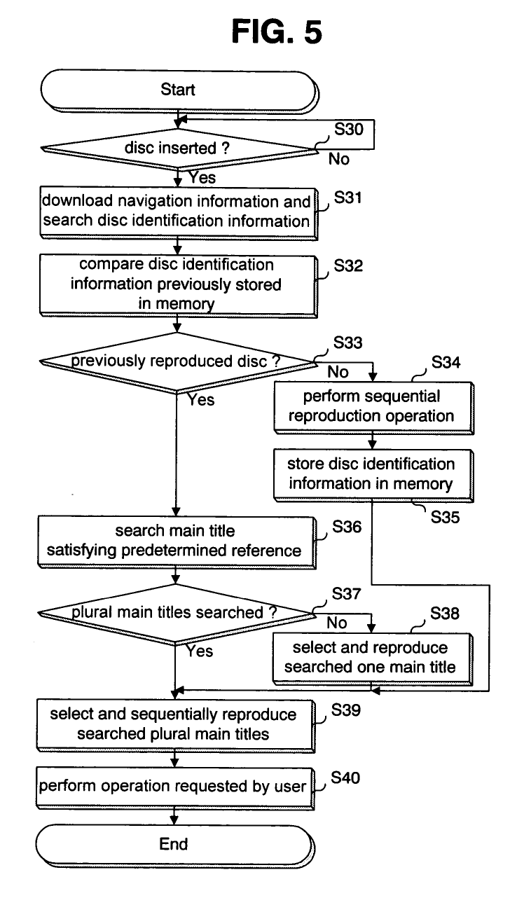

FIG. 5 is a flowchart illustrating an operational procedure of selectively reproducing main titles by an optical disc device according to another embodiment of the present invention. This procedure is implemented in the optical disc device 100 of FIG. 1; however, the present invention is not limited thereto and the procedure can be implemented in other device or system.

Referring to FIG. 5, since steps S30 to S33, step S34, and step S35 correspond to step S10 to S13, step S14, and step S15, respectively, a description about these steps will be omitted in order to avoid redundancy.

If it is determined that the currently inserted optical disc 10 has been previously reproduced in the optical disc device 100 in step S33, the microcomputer 16 searches for a main title satisfying a predetermined reference based on navigation information read out from the optical disc 10 and downloaded into the memory 18 in step S36. For example, as shown in FIG. 4, a main title having a data length satisfying a preset reference value is searched based on each title information included in a video title set of the navigation information.

If one main title is found as a result of the searching in step S37, the microcomputer 16 skips the reproduction of warnings, previews, advertisements, etc. recorded before the main title and directly reproduces only the one searched main title in step S38. If a plurality of main titles (e.g., Title #3 and Title #4) are searched and found in step S37, the microcomputer 16 skips the warnings, previews, and/or advertisements, and directly reproduces only the plurality of main titles according to a physical recording sequence regardless of each data length of each main title in step S39. In the alternative, the plurality of the main titles may be reproduced according to a reproduction sequence requested by the user instead of the physical recording sequence. (e.g., a menu is provided and used for a user to set the order in which these main titles are to be played for the user) Then, the microcomputer 16 performs operations requested by a user in step S40.

As described above, an optical device according to the present invention sequentially reproduces all titles including warning data and advertisement data from an optical disc which is initially reproduced. But for the optical discs that have been already reproduced in the optical device, the invention automatically bypasses the warnings, previews, advertisements, etc. (since they have been already played), and automatically and directly reproduces only a main title or only a plurality of main titles satisfying a predetermined reference.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method for reproducing data in a recording medium device, the method comprising:
determining, by the recording medium device, whether or not there is a reproduction history of an inserted recording medium in the recording medium device; and
directly accessing and reproducing at least one main title from the recording medium if the determining step determines that there is a reproduction history of the recording medium in the recording medium device.

2. The method as claimed in claim 1, wherein the directly accessing and reproducing step includes:
automatically bypassing reproduction of at least one warning and/or advertisement recorded on the recording medium.

3. The method as claimed in claim 2, wherein the at least one warning and/or advertisement is recorded in front of the at least one main title in a data area of the recording medium.

4. The method as claimed in claim 1, wherein the determining step includes:
comparing certain information recorded on the recording medium with recording medium identification information stored in the recording medium device.

5. The method as claimed in claim 4, wherein the determining step determines that there is a reproduction history of the recording medium if the comparing step indicates that the certain information medium matches identification data included in the recording medium identification information stored in the recording medium device.

6. The method as claimed in claim 4, wherein the certain information is a disc ID of the recording medium.

7. The method as claimed in claim 4, wherein the certain information is the number of chapters or sectors for a predetermined title recorded on the recording medium.

8. The method as claimed in claim 7, wherein the predetermined title is a first title or a title having a longest data length recorded on the recording medium.

9. The method as claimed in claim 1, wherein in the directly accessing and reproducing step, the at least one main title is a title with a longest data length among a plurality of titles recorded on the recording medium.

10. The method as claimed in claim 2, further comprising:
reproducing sequentially the at least one warning and/or advertisement and the at least one main title, if the determining step determines that there is no reproduction history of the recording medium in the recording medium.

11. The method as claimed in claim 4, wherein certain characteristic information of all recording mediums reproduced in the recording medium device for the first time is stored as part of the recording medium identification information.

12. The method as claimed in claim 1, wherein the directly accessing and reproducing step includes:
locating any title that satisfies a predetermined criterion among a plurality titles recorded on the recording medium, if there is a reproduction history of the recording medium in the recording medium device; and
directly reproducing the located title(s) as the at least one main title.

13. The method as claimed in claim 12, wherein the predetermined criterion is whether or not a reproduction time of each title exceeds a preset value.

14. The method as claimed in claim 12, wherein if there are multiple located titles, all the located titles are sequentially reproduced according to a physical recording sequence.

15. The method as claimed in claim 12, wherein if there are multiple located titles, all the located titles are sequentially reproduced according to a sequence requested by a user.

16. The method as claimed in claim 1, wherein the recording medium is an optical disc.

17. An apparatus for reproducing data in a recording medium, the apparatus comprising:
a reproducing unit; and
a controller to determine whether or not there is a reproduction history of an inserted recording medium in the apparatus, and to control the reproducing unit to directly access and reproduce at least one main title from the recording medium if there is a reproduction history of the recording medium in the apparatus.

18. The apparatus as claimed in claim 17, wherein the controller automatically bypasses reproduction of at least one warning and/or advertisement recorded on the recording medium.

19. The apparatus as claimed in claim 18, wherein the at least one warning and/or advertisement is recorded in front of the at least one main title in a data area of the recording medium.

20. The apparatus as claimed in claim 17, wherein the controller compares certain information recorded on the recording medium with recording medium identification information stored in the apparatus.

21. The apparatus as claimed in claim 20, wherein the controller determines that there is a reproduction history of the recording medium if the certain information medium matches identification data included in the recording medium identification information stored in the apparatus.

22. The apparatus as claimed in claim 20, wherein the certain information is a disc ID of the recording medium.

23. The apparatus as claimed in claim 20, wherein the certain information is the number of chapters or sectors for a predetermined title recorded on the recording medium.

24. The apparatus as claimed in claim 23, wherein the predetermined title is a first title or a title having a longest data length recorded on the recording medium.

25. The apparatus as claimed in claim 17, wherein the at least one main title is a title with a longest data length among a plurality of titles recorded on the recording medium.

26. The apparatus as claimed in claim 18, wherein the reproducing unit reproduces sequentially the at least one warning and/or advertisement and the at least one main title, if the controller determines that there is no reproduction history of the recording medium in the recording medium.

27. The apparatus as claimed in claim 20, wherein certain characteristic information of all recording mediums reproduced in the apparatus for the first time is stored as part of the recording medium identification information.

28. The apparatus as claimed in claim 17, wherein the controller locates any title that satisfies a predetermined criterion among a plurality titles recorded on the recording medium if there is a reproduction history of the recoding medium in the apparatus, and controls the reproducing unit to directly reproduce the located title(s) as the at least one main title.

29. The apparatus as claimed in claim 28, wherein the predetermined criterion is whether or not a reproduction time of each title exceeds a preset value.

30. The apparatus as claimed in claim 28, wherein if there are multiple located titles, the reproducing unit reproduces all the located titles sequentially according to a physical recording sequence.

31. The apparatus as claimed in claim 28, wherein if there are multiple located titles, the reproducing unit reproduces all the located titles sequentially according to a sequence requested by a user.

32. The apparatus as claimed in claim 17, wherein the recording medium is an optical disc.
